(19) United States
(12) Patent Application Publication
(10) Pub. No.: US 2010/0209796 A1
(43) Pub. Date: Aug. 19, 2010

(54) FUEL CELL SYSTEM AND METHOD FOR CONTROLLING REACTANT GAS SUPPLY AMOUNT

(75) Inventor: Norimasa Ishikawa, Asahikawa-shi (JP)

Correspondence Address: KENYON & KENYON LLP, 1500 K STREET N.W., SUITE 700, WASHINGTON, DC, 20005, US

(73) Assignee: TOYOTA JIDOSHA KABUSHIKI KAISHA, Toyota-shi (JP)

(21) Appl. No.: 12/678,441

(22) PCT Filed: Sep. 3, 2008
(86) PCT No.: PCT/JP2008/065824

§ 371 Date: Mar. 16, 2010

(30) Foreign Application Priority Data
Sep. 19, 2007 (JP) 2007-242623

(51) Int. Cl. H01M 8/04

(52) U.S. Cl. 429/443

(57) ABSTRACT

The amount of a reactant gas to be supplied can be controlled efficiently with a reduction in the effort required. A control unit judges whether or not the state where an atmospheric pressure detection value detected by an atmospheric pressure sensor does not fall within the range of 0.6 V to 4.48 V has continued for or longer than 50 ms. If the state has not continued for or longer than 50 ms, the control unit outputs an atmospheric pressure correction value by converting the atmospheric pressure detection value into an atmospheric pressure value and then passing the atmospheric pressure value through a low-pass filter. On the other hand, if the state has continued for or longer than 50 ms, the control unit outputs 101.3 kPa.abs which serves as a substitute value for the atmospheric pressure correction value. The control unit then converts respective pressure detection values detected by pressure sensors into gate pressure values, and adds the atmospheric pressure correction value to each of the gate pressure values so as to calculate absolute pressures of the respective reactant gases in an oxidant gas pipe system and a hydrogen gas pipe system. The control unit controls the supply amount of each of the reactant gases with respect to a fuel cell based on these absolute pressures.

This is a 371 national phase application of PCT/JP2008/065824 filed 3 Sep. 2008, which claims priority to Japanese Patent Application No. 2007-242623 filed 19 Sep. 2007, the contents of which are incorporated herein by reference.

### FIELD OF THE INVENTION

The present invention relates to a fuel cell system and a method for controlling a reactant gas supply amount.

### BACKGROUND OF THE INVENTION

A fuel cell system uses a fuel cell, as an energy source, which generates electric power through an electrochemical reaction of a fuel gas and an oxidant gas serving as reactant gases. In order to operate the fuel cell efficiently, an amount of each of the reactant gases to be supplied to the fuel cell needs to be controlled in order to respond to various situations. An example of a technique of controlling a reactant gas supply amount is the technique in which: a pipe for supplying a reactant gas to a fuel cell is provided with a pressure sensor; and the reactant gas supply amount is controlled based on a value detected by the pressure sensor (see, e.g., Patent Document 1).

Patent Document 1: Japanese laid-open patent publication No. 2004-342475

### SUMMARY OF THE INVENTION

### Problem to be Solved by the Invention

Time and effort are required for the manufacturing of absolute pressure sensors which are used as pressure sensors. Therefore, the number of manufacturing steps can be reduced further by using, as a pressure sensor, a gauge pressure sensor, which is manufactured more easily than an absolute pressure sensor. However, when using the gauge pressure sensor, an atmospheric pressure needs to be added to a gauge pressure detected by that sensor so as to be converted into an absolute pressure. Accordingly, in this case, an atmospheric pressure sensor for measuring an atmospheric pressure is required separately.

When a malfunction is caused in the atmospheric pressure sensor due to breakage, short-circuit, etc., an absolute pressure calculated by using a value detected by the atmospheric pressure sensor will have a value different from an actual absolute pressure. In short, in this case, the amount of a reactant gas to be supplied to a fuel cell cannot be controlled efficiently.

The present invention has been made to solve the above-described problem in prior art, and has an object to provide a fuel cell system and a method for controlling a reactant gas supply amount by which the reactant gas supply amount is controlled efficiently with a reduction in the effort required.

### Means for Solving the Problem

In order to solve the above-described problem, the present invention provides a fuel cell system including a fuel cell which generates electric power due to an electrochemical reaction of a reactant gas upon a supply of the reactant gas, including: a supply/discharge mechanism which supplies and discharges the reactant gas; a pressure sensor which detects a pressure of the reactant gas in the supply/discharge mechanism; an atmospheric pressure sensor which detects an atmospheric pressure; correction means which corrects a detection value detected by the atmospheric pressure sensor; and control means which controls a supply amount of the reactant gas with respect to the fuel cell by using the detection value detected by the pressure sensor and a correction value obtained through a correction by the correction means.

The present invention also provides a method for controlling a reactant gas supply amount with respect to a fuel cell which generates electric power due to an electrochemical reaction of a reactant gas upon a supply of the reactant gas, including: a pressure detection step of detecting a pressure of the reactant gas in a supply/discharge mechanism which supplies and discharges the reactant gas; an atmospheric pressure detection step of detecting an atmospheric pressure; a correction step of correcting a detection value detected in the atmospheric pressure detection step; and a control step of controlling the reactant gas supply amount with respect to the fuel cell by using the detection value detected in the pressure detection step and the correction value obtained through a correction in the correction step.

According to the invention, the value detected by the atmospheric pressure sensor is corrected by the correction means, and the reactant gas supply amount with respect to the fuel cell can be controlled by using the resultant correction value and the pressure value of the reactant gas in the supply/discharge mechanism. Accordingly, a gauge pressure sensor may be used as the pressure sensor. In addition, even when the atmospheric pressure sensor outputs a value different from an actual atmospheric pressure due to a malfunction, etc., the output value can be corrected. Consequently, the reactant gas supply amount can be controlled efficiently with a reduction in the effort required.

In the above fuel cell system, the correction means can correct the detection value detected by the atmospheric pressure sensor by passing the detection value through a low-pass filter.

With such a configuration, even when, for example, the detection value rapidly changes due to a malfunction, etc. of the atmospheric pressure sensor, the degree of the change can be lessened, thereby preventing a rapid change of the reactant gas supply amount.

In the above fuel cell system, the correction means can provide an upper limit and a lower limit for the correction value.

With such a configuration, even when, for example, an impossible value for an actual atmospheric pressure is output due to a malfunction, etc. of the atmospheric pressure sensor, the output value can be corrected to fall within the range of the set upper limit to the set lower limit.

In the above fuel cell system, when the detection value detected by the atmospheric pressure sensor does not fall within a predetermined range, the correction means can perform a correction by substituting a preset substitute value for the detection value.

With such a configuration, when, for example, the detection value does not fall within a predetermined range due to a malfunction, etc. of the atmospheric pressure sensor, a substitute value can be substituted for the detection value. Therefore, even when a value completely different from an actual atmospheric pressure is output due to a malfunction, etc. of the atmospheric pressure sensor, a substitute value indicating a standard atmospheric pressure can be substituted for the detection value.

In the above fuel cell system, when the state where the detection value detected by the atmospheric pressure sensor does not fall within a predetermined range has continued for a predetermined time, the correction means can start a substitution of the substitute value for the detection value.

With such a configuration, when the atmospheric pressure sensor outputs a detection value that does not fall within the predetermined range temporarily due to a factor other than a malfunction, the substitution of the substitute value can be restricted so as not to be performed.

In the above fuel cell system, after the substitution of the substitute value for the detection value is started, when the detection value detected by the atmospheric pressure sensor falls within a predetermined range for a predetermined time, the correction means can end the substitution of the substitute value for the detection value.

With such a configuration, even after the substitution of the substitute value for the detection value is started, when the atmospheric pressure sensor returns to a normal state, control can be carried out using the value detected by the atmospheric pressure sensor again.

### Effect of the Invention

According to the present invention, the reactant gas supply amount can be controlled efficiently with a reduction in the effort required.

### BRIEF DESCRIPTION OF THE DRAWINGS

FIG. 1 is a configuration diagram schematically illustrating a fuel cell system in an embodiment.

FIG. 2 is a diagram illustrating the relationship between an atmospheric pressure detection value and an atmospheric pressure correction value.

FIG. 3 is a flowchart explaining processing of controlling a reactant gas supply amount with respect to a fuel cell in the fuel cell system shown in FIG. 1.

### DESCRIPTION OF REFERENCE NUMERALS

1: fuel cell system, 2: fuel cell, 3: oxidant gas pipe system, 4: hydrogen gas pipe system, 5: control unit, 30: filter, 31: compressor, 32: air supply flow path, 33: air discharge flow path, 34: backpressure regulating valve, 35: humidifier, 40: hydrogen tank, 41: hydrogen supply flow path, 42: circulation flow path, 43: main stop valve, 44 and 45: regulators, 46 and 47: cutoff valves, 48: hydrogen pump, 49: gas-liquid separator, 50: exhaust/drain valve, 51: discharge flow path, 52: diluter, P1 and P2: pressure sensors, P3: atmospheric pressure sensor

### DETAILED DESCRIPTION

A preferred embodiment of a fuel cell system and a method for controlling a reactant gas supply amount according to the present invention will be described below with reference to the attached drawings. In this embodiment, the case of using the fuel cell system of the invention as an electric power generation system mounted on a fuel cell hybrid vehicle (FCHV) will be described.

In the fuel cell system in this embodiment, a gauge pressure sensor detects the pressure of a reactant gas in an supply/discharge flow path for supplying or discharging the reactant gas, and an absolute pressure is calculated by using the value detected by this gauge pressure sensor and the value obtained by correcting the value detected by an atmospheric pressure sensor. An amount of the reactant gas to be supplied to a fuel cell is then controlled based on the absolute pressure.

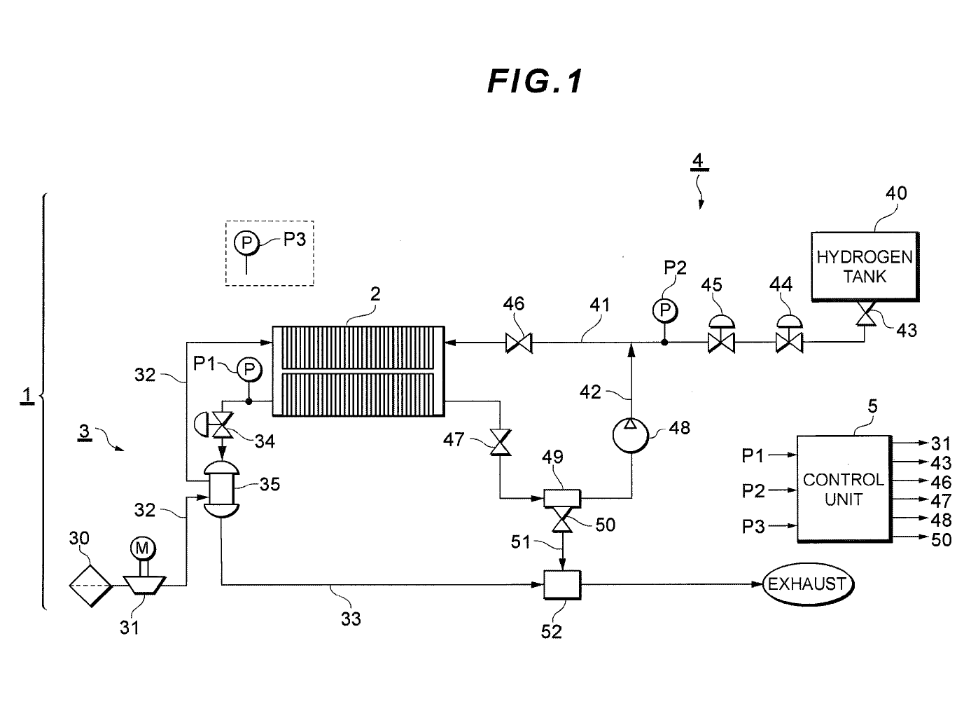

First, the configuration of the fuel cell system in this embodiment will be described with reference to FIG. 1. FIG. 1 is a configuration diagram schematically illustrating the fuel cell system in this embodiment.

As shown in the figure, a fuel cell system 1 includes: a fuel cell 2 which generates electric power due to an electrochemical reaction between an oxidant gas and a fuel gas, which serve as reactant gases; an oxidant gas pipe system 3 (supply/discharge mechanism) which supplies air serving as the oxidant gas to the fuel cell 2; a hydrogen gas pipe system 4 which supplies hydrogen serving as the fuel gas to the fuel cell 2; and a control unit 5 which performs control over the entire system.

The fuel cell 2 is constituted by a stack structure of a plurality of stacked unit cells each of which generates electric power upon the supply of the reactant gas. The voltage of a part of the direct-current power generated by the fuel cell 2 is decreased by a DC/DC converter (not shown) and then used for charging a secondary battery (not shown) which serves as a battery.

The oxidant gas pipe system 3 includes: a compressor 31 (oxidant gas supply source) for compressing air taken in through a filter 30 and sending the compressed air serving as the oxidant gas; an air supply flow path 32 for supplying the oxidant gas to the fuel cell 2; and an air discharge flow path 33 for discharging an oxidant-off gas discharged from the fuel cell 2. The air supply flow path 32 and the air discharge flow path 33 are provided with a humidifier 35 for humidifying the oxidant gas pumped from the compressor 31 by using the oxidant-off gas discharged from the fuel cell 2 through a backpressure regulating valve 34. The oxidant-off gas, which has been subjected to water exchange, etc., in the humidifier 35 is eventually exhausted as exhaust air into air outside the system. Provided on the upstream side of the backpressure regulating valve 34 is a pressure sensor P1 for detecting the pressure of the oxidant gas in the oxidant gas pipe system 3. The pressure sensor P1 is a gage pressure sensor. Gage pressure sensors are pressure sensors that are manufactured easily compared with absolute pressure sensors.

The hydrogen gas pipe system 4 includes: a hydrogen tank 40 serving as a fuel supply source which stores hydrogen gas at a high pressure (e.g., 70 MPa); a hydrogen supply flow path 41 serving as a fuel supply flow path for supplying the hydrogen gas in the hydrogen tank 40 to the fuel cell 2; and a circulation flow path 42 for returning a hydrogen-off gas discharged from the fuel cell 2 to the hydrogen supply flow path 41. Note that the hydrogen gas pipe system 4 is an embodiment of a fuel supply system in the invention. Instead of the hydrogen tank 40 in this embodiment, for example, a reformer for reforming, by using water vapor, hydrocarbon fuel into a hydrogen-enriched fuel gas and a high-pressure gas tank which brings the fuel gas reformed by the reformer into a high-pressure state for pressure accumulation may be employed as the fuel supply source. A tank containing a hydrogen absorbing alloy may also be employed as the fuel supply source.

The hydrogen supply flow path 41 is provided with: a main stop valve 43 for interrupting or allowing the supply of hydrogen gas from the hydrogen tank 40; regulators 44 and 45 for regulating the pressure of hydrogen gas to a preset secondary pressure; and a cutoff valve 46 for interrupting or allowing the supply of hydrogen gas from the hydrogen supply flow path 41 to the fuel cell 2. Also, provided on the downstream side of the regulator 45 is a pressure sensor P2 for detecting the pressure of the hydrogen gas in the hydrogen gas pipe system 4. The pressure sensor P2 is a gage pressure sensor.

The circulation flow path 42 is provided with: a cutoff valve 47 for interrupting or allowing the flow of hydrogen-off gas from the fuel cell 2 to the circulation flow path 42; and a hydrogen pump 48 for pressurizing the hydrogen-off gas in the circulation flow path 42 and sending the resultant hydrogen-off gas to the hydrogen supply flow path 41. Also, connected to the circulation path 42 is a discharge flow path 51 through a gas-liquid separator 49 and an exhaust/drain valve 50. The gas-liquid separator 49 collects water from the hydrogen-off gas. The exhaust/drain valve 50 discharges (purges) the water collected by the gas-liquid separator 49 and the hydrogen-off gas containing impurities in the circulation flow path 42. The hydrogen-off gas discharged from the exhaust/drain valve 50 is diluted by a diluter 52 to merge with the oxidant-off gas in the air discharge flow path 33.

The control unit 5 detects the operation amount of an acceleration operating member (accelerator, etc.) provided in a fuel cell vehicle, and controls operation of various devices in the system upon receiving control information such as an acceleration required value (e.g., amount of generation of electric power required from a power consuming device such as a traction motor). Note that power consuming devices include not only the traction motor but also auxiliary apparatuses (e.g., motors for the compressor 31 and the hydrogen pump 48, etc.) necessary for operating the fuel cell 2, actuators used in various devices relating to the driving of vehicles (a change gear, wheel control device, steering device, suspension device, etc.), an air conditioning device (air conditioner) for an occupant space, lighting, audio equipment, etc.

Based on a value detected by an atmospheric pressure sensor P3 for measuring an atmospheric pressure (hereinafter referred to as atmospheric pressure detection value), the control unit 5 outputs a correction value (hereinafter referred to as atmospheric pressure correction value). The control unit 5 calculates an absolute pressure value by adding the atmospheric pressure correction value to a value obtained by converting the value detected by the pressure sensor P1 or P2 (hereinafter referred to as pressure detection value) into a gauge pressure (hereinafter referred to as gauge pressure value). The control unit 5 uses this absolute pressure value to control the supply amount of the oxidant gas or hydrogen gas to be supplied to the fuel cell 2. The atmospheric pressure sensor P3 is arranged in, e.g., an engine room.

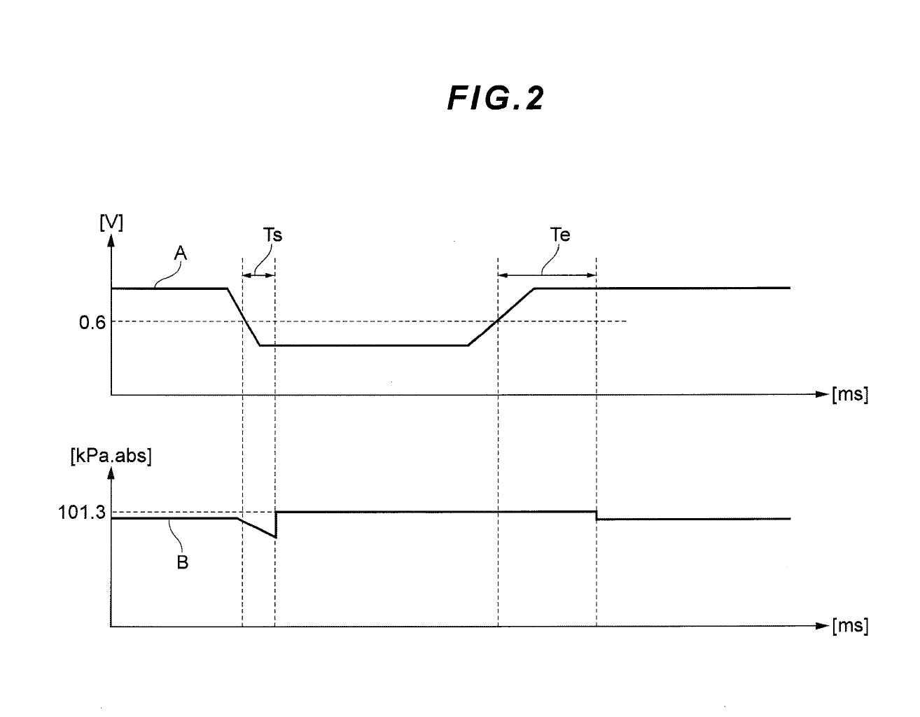

The relationship between the atmospheric pressure detection value and the atmospheric pressure correction value will specifically be described with reference to FIG. 2. The control unit 5 converts the atmospheric pressure detection value M detected by the atmospheric pressure sensor P3 into an atmospheric pressure value [kPa.abs], and then passes the atmospheric pressure value [kPa.abs] through a low-pass filter so as to output the atmospheric pressure correction value [kPa.abs]. In FIG. 2, A indicates an atmospheric pressure detection value, and B indicates an atmospheric pressure correction value.

The control unit 5 judges whether or not the state where the atmospheric pressure detection value A does not fall within the range of a first threshold to a second threshold (e.g., 0.6 V to 4.48 V) has continued for or longer than, e.g., 50 ms. If the state has continued for or longer than 50 ms, the control unit 5 starts substitute value output processing. The substitute value output processing refers to processing of outputting a standard atmospheric pressure, 101.3 kPa.abs, as a substitute value which serves as the atmospheric pressure correction value B. Ts shown in FIG. 2 represents a period during which 50 ms passes after the atmospheric pressure detection value A reaches a value of less than 0.6V. After this period Ts passes, 101.3 kPa.abs is output to serve as the atmospheric pressure correction value B.

After starting the substitute value output processing, the control unit 5 judges whether or not the state where the atmospheric pressure detection value A falls within the range of the first threshold to the second threshold (e.g., 0.6 V to 4.48 V) has continued for or longer than, e.g., 6000 ms. If the state has continued for or longer than 6000 ms, the control unit 5 ends the substitute value output processing and outputs the atmospheric pressure correction value B under normal conditions. Te shown in FIG. 2 represents a period during which 6000 ms passes after the atmospheric pressure detection value A has fallen within the range of 0.6 V to 4.48 V. After this period Te passes, a normal atmospheric pressure correction value, which is calculated by converting the atmospheric pressure detection value A into an atmospheric pressure value and passing the atmospheric pressure value through the low-pass filter, is output as the atmospheric pressure correction value B.

Here, the control unit 5 physically includes, e.g., a CPU, a ROM or HDD for storing a control program or control data processed in the CPU, a RAM used as an area for various operations mainly for control processing, and an input-output interface. These elements are connected to one another via buses. Connected to the input-output interface are not only various sensors such as the pressure sensors P1 and P2 and the atmospheric pressure sensor P3 but also various drivers for driving the compressor 31, the main stop valve 43, the cutoff valves 46 and 47, the hydrogen pump 48, the exhaust/drain valve 50, etc.

The CPU receives the respective results detected by the pressure sensors P1 and P2 and the atmospheric pressure sensor P3 via the input-output interface in accordance with the control program stored in the ROM, and processes the results using various data, etc. in the RAM, thereby controlling the amount of each of the reactant gases to be supplied to the fuel cell 2. The CPU also outputs control signals to the various drivers through the input-output interface, thereby controlling the entire fuel cell system 1.

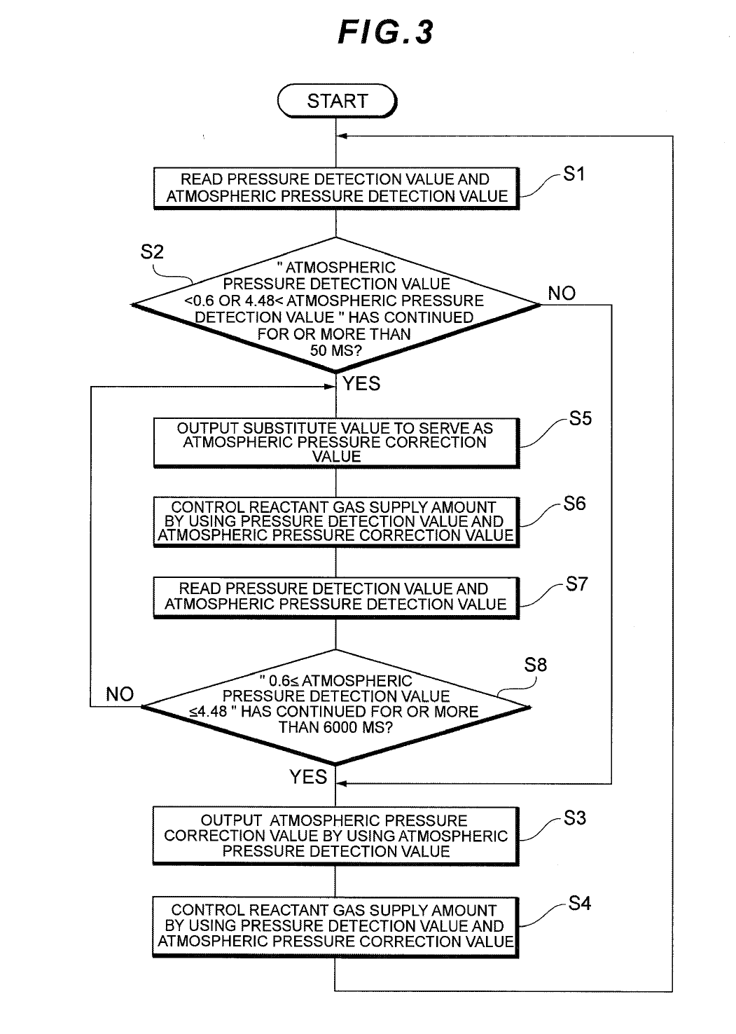

Next, processing of controlling a reactant gas supply amount with respect to a fuel cell in this embodiment will be described using the flowchart in FIG. 3. This processing of controlling a reactant gas supply amount is processing performed repeatedly until, after being started, the fuel cell 2 is stopped or suspended due to an intermittent operation.

First, upon the start of the fuel cell 2, the control unit 5 reads the respective pressure detection values [V] detected by the pressure sensors P1 and P2 and the atmospheric pressure detection value [V] detected by the atmospheric pressure sensor P3 from the relevant sensors (Step S1).

The control unit 5 judges whether or not the state where the atmospheric pressure detection value does not fall within the range of 0.6 V to 4.48 V has continued for or longer than 50 ms based on the atmospheric pressure detection value read in Step S1 above (Step S2). If the result of this judgment is NO (Step S2; NO), the control unit 5 outputs the atmospheric pressure correction value [kPa.abs] by converting the atmospheric pressure detection value [V] into an atmospheric pressure value [kPa.abs] and passing the atmospheric pressure value [kPa.abs] through the low-pass filter (Step S3).

The control unit 5 then converts the respective pressure detection values [V] read in Step S1 into gauge pressure values [kPa.G], and adds the atmospheric pressure correction value [kPa.abs] to each of the gauge pressure values so as to calculate absolute pressures [kPa.abs] of the respective reactant gases in the oxidant gas pipe system 3 and the hydrogen gas pipe system 4. The control unit 5 then controls the supply amount of each of the reactant gases with respect to the fuel cell 2 based on these absolute pressures (Step S4). The control unit 5 proceeds to Step S1 described above.

On the other hand, if the result of the judgment in Step S2 above is that the above state has continued for or longer than 50 ms (Step S2; YES), the control unit 5 outputs 101.3 kPa.abs as the substitute value which serves as the atmospheric pressure correction value (Step S5).

The control unit 5 subsequently converts the pressure detection values [V] read from the respective sensors into gauge pressure values [kPa.G], and adds 101.3 kPa.abs serving as the atmospheric pressure correction value to each of the gauge pressure values, thereby calculating the respective absolute pressures [kPa.abs] in the oxidant gas pipe system 3 and the hydrogen gas pipe system 4. The control unit 5 then controls the supply amount of each of the reactant gases with respect to the fuel cell 2 based on these absolute pressures (Step S6).

The control unit 5 then reads the pressure detection values [V] detected by the pressure sensors P1 and P2 and the atmospheric pressure detection value [V] detected by the atmospheric pressure sensor P3 from the relevant sensors (Step S7).

The control unit 5 subsequently judges whether or not the state where the atmospheric detection value falls within the range of 0.6 V to 4.48 V has continued for or longer than 6000 ms based on the atmospheric pressure detection value read in Step S7 above (Step S8). If the result of this judgment is NO (Step S8; NO), the control unit 5 proceeds to Step S5 described above.

On the other hand, if the result of the judgment in Step S8 above is that the above state has continued for or longer than 6000 ms (Step S8; YES), the control unit 5 proceeds to Step S3 described above.

As described above, according to the fuel cell system 1 in this embodiment, the atmospheric pressure detection value detected by the atmospheric pressure sensor P3 is corrected, and the supply amounts of the respective reactant gases with respect to the fuel cell 2 can be controlled by using the atmospheric pressure correction value obtained through correction and the pressure values of the respective reactant gases in the oxidant gas pipe system 3 and the hydrogen gas pipe system 4. Accordingly, the gauge pressure sensors P1 and P2, which can be manufactured easily compared with absolute pressure sensors, can be used as pressure sensors, and moreover, even when the atmospheric pressure sensor P3 outputs a value different from an actual atmospheric pressure due to a malfunction, etc., the output value can be corrected. Consequently, the reactant gas supply amount can be controlled efficiently with a reduction in the effort required.

According to the fuel cell system 1 in this embodiment, where the atmospheric pressure detection value detected by the atmospheric pressure sensor P3 does not fall within a predetermined range (e.g., the range of 0.6 V to 4.48 V), a substitute value (e.g., 101.3 kPa.abs) can be used as the atmospheric pressure correction value. As a result, even when the atmospheric pressure sensor P3 outputs a value completely different from an actual atmospheric pressure due to a malfunction, etc., the output value can be replaced by the substitute value indicating a standard atmospheric pressure.

According to the fuel cell system 1 in this embodiment, only when the state where the atmospheric pressure detection value detected by the atmospheric pressure sensor P3 does not fall within a predetermined range (e.g., the range of 0.6 V to 4.48 V) has continued for or longer than a predetermined period (e.g., 50 ms), a substitution of the substitute value can be carried out. Accordingly, when the atmospheric pressure sensor P3 outputs a detection value that does not fall within the predetermined range temporarily due to a factor other than a malfunction, the substitution of the substitute value can be limited not to be performed.

According to the fuel cell system 1 in this embodiment, where, after the substitution of the substitute value for the atmospheric pressure detection value is started, the atmospheric pressure detection value detected by the atmospheric pressure sensor P3 falls within a predetermined range (e.g., the range of 0.6 V to 4.48 V) for a predetermined time (e.g., 6000 ms), the substitution of the substitute value for the atmospheric pressure detection value can be completed. Accordingly, when the atmospheric pressure sensor P3 returns to a normal state, control can be carried out using the value detected by the atmospheric pressure sensor P3.

In the embodiment described above, when calculating the atmospheric pressure correction value, the atmospheric pressure value obtained by converting the atmospheric pressure detection value is passed through the low-pass filter, but that atmospheric pressure value does not always need to be passed through the low-pass filter. However, passing the atmospheric pressure value through the low-pass filter allows noise contained in the atmospheric pressure detection value to be removed, and also, enables the degree of change to be lessened even when the atmospheric pressure detection value rapidly changes due to a malfunction, etc. of the atmospheric pressure sensor. Accordingly, the reactant gas supply amount can be prevented from changing rapidly, and the efficiency of the control of the reactant gas supply amount can be improved. Also, when the above value is passed through the low-pass filter, a cutoff frequency for the low-pass filter is preferably set low. For example, when an operation period for the atmospheric pressure correction value is 8.192 ms, the frequency with respect to which a reference time is 1998.848 ms (8.192×244) can be set as the cutoff frequency. A rapid change of the atmospheric pressure detection value can be lessened further by setting a lower cutoff frequency.

An upper limit and a lower limit may be set for the atmospheric pressure correction value in the above embodiment. The upper limit and the lower limit are preferably set around the upper limit and the lower limit for a possible value of an atmospheric pressure. For example, 110 kPa.abs and 65 kPa.abs may be set as the upper limit and the lower limit, respectively. Accordingly, even when an impossible value of an atmospheric pressure is output due to a malfunction, etc. of the atmospheric pressure sensor P3, the atmospheric pressure correction value can be made to fall within the range of possible values of an atmospheric pressure.

In the above embodiment, a predetermined duration time (50 ms or 6000 ms) is provided for the starting or ending of substitute value output processing. However, this duration time can be set arbitrarily, and may be set to, e.g., 0 ms. Moreover, the range of the atmospheric pressure detection values is set to be from 0.6 V to 4.48 V as one of the conditions for starting or ending substitute value output processing, but the range of the atmospheric pressure detection values is not limited to the above range, and can be set arbitrarily. The range of the atmospheric pressure detection values is preferably set to the range of possible values of an atmospheric pressure value.

Although the above embodiment has described the case where the fuel cell system of the invention is mounted on a fuel cell vehicle, the fuel cell systems of the invention may be applied not only to fuel cell vehicles but also to other various mobile objects (e.g., robots, ships and airplanes). The fuel cell systems of the invention may also be applied to stationary power generating systems used as power generating equipment for constructions (e.g., houses and buildings).

### INDUSTRIAL APPLICABILITY

The fuel cell system and method for controlling a reactant gas supply amount according to the present invention are suitable for efficiently controlling a reactant gas supply amount with respect to a fuel cell.

1. A fuel cell system including a fuel cell which generates electric power due to an electrochemical reaction of a reactant gas upon a supply of the reactant gas, comprising:
a supply/discharge mechanism which supplies and discharges the reactant gas;
a gauge pressure sensor which detects a pressure of the reactant gas in the supply/discharge mechanism;
an atmospheric pressure sensor which detects an atmospheric pressure;
a correction unit which corrects a detection value detected by the atmospheric pressure sensor by passing the detection value through a lowpass-filer; and
a control unit which controls a supply amount of the reactant gas with respect to the fuel cell by using a value obtained by adding the detection value detected by the gauge pressure sensor to a correction value obtained through a correction by the correction unit.

2. (canceled)

3. The fuel cell system according to claim 1, wherein the correction unit provides an upper limit and a lower limit for the correction value.

4. The fuel cell system according to 1, wherein, when the detection value detected by the atmospheric pressure sensor does not fall within a predetermined range, the correction unit performs a correction by substituting a preset substitute value for the detection value.

5. The fuel cell system according to claim 4, wherein, when a state where the detection value detected by the atmospheric pressure sensor does not fall within a predetermined range has continued for a predetermined time, the correction unit starts a substitution of the substitute value for the detection value.

6. The fuel cell system according to claim 5, wherein, after the substitution of the substitute value for the detection value is started, when the detection value detected by the atmospheric pressure sensor falls within a predetermined range for a predetermined time, the correction unit ends the substitution of the substitute value for the detection value.

7. A method for controlling a reactant gas supply amount with respect to a fuel cell which generates electric power due to an electrochemical reaction of a reactant gas upon a supply of the reactant gas, comprising:
a gauge pressure detection step of detecting a pressure of the reactant gas in a supply/discharge mechanism which supplies and discharges the reactant gas;
an atmospheric pressure detection step of detecting an atmospheric pressure;
a correction step of correcting a detection value detected in the atmospheric pressure detection step by passing the detection value through a low-pass filter; and
a control step of controlling the reactant gas supply amount with respect to the fuel cell by using a value obtained by adding the detection value detected in the gauge pressure detection step to the correction value obtained through a correction in the correction step.
